(19) United States
(12) Patent Application Publication
(10) Pub. No.: US 2003/0083993 A1
(43) Pub. Date: May 1, 2003

(54) Photocheck

(76) Inventor: Mark Lumpkin, St. Louis, MO (US)

Correspondence Address: Mark Lumpkin, 7213 Teal, St. Louis, MO, 63133, US

(21) Appl. No.: 10/039,631

(22) Filed: Oct. 26, 2001

(51) Int. Cl. G06F 17/60

(52) U.S. Cl. 705/45

(57) ABSTRACT

The purpose of this abstract is to enable the PTO and the public the ability to understand the nature of the technical disclosures of this new invention. Photocheck is a new form of personal bank checks. Never before has a photograph been placed on a personal bank check to identify consumers. The Photocheck will be specifically designed to combat identity fraud via personal bank checks. This new invention will make consumers feel move at ease of someone stealing their personal account bank checks and writing fraudulent checks without the consumers permission. With the increase of identity fraud on the rise, this invention could not have come at a better time.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention would be classified under the field of Photo Identification. This invention is designed to identify consumers via personal bank checks. It will eliminate bank check fraud. No problems are associated with this invention.

### BRIEF SUMMARY OF THE INVENTION

Photocheck is a photo identification personal bank check that is designed to be used by Consumers wherever personal checks are accepted. It will help to eliminate identity theft Caused by personal checks stolen and used fraudulently. Each personal bank check given to account holders via a financial institution, will have the corresponding photo of the account holder in the upper left hand corner of the check.

### BRIEF DESCRIPTION OF THE SEVERAL VIEWS OF THE DRAWING

The description of the drawings are as follows:

FIG. 1. Photo

FIG. 2. Personal Bank Check

FIG. 3. Photo of personal bank check

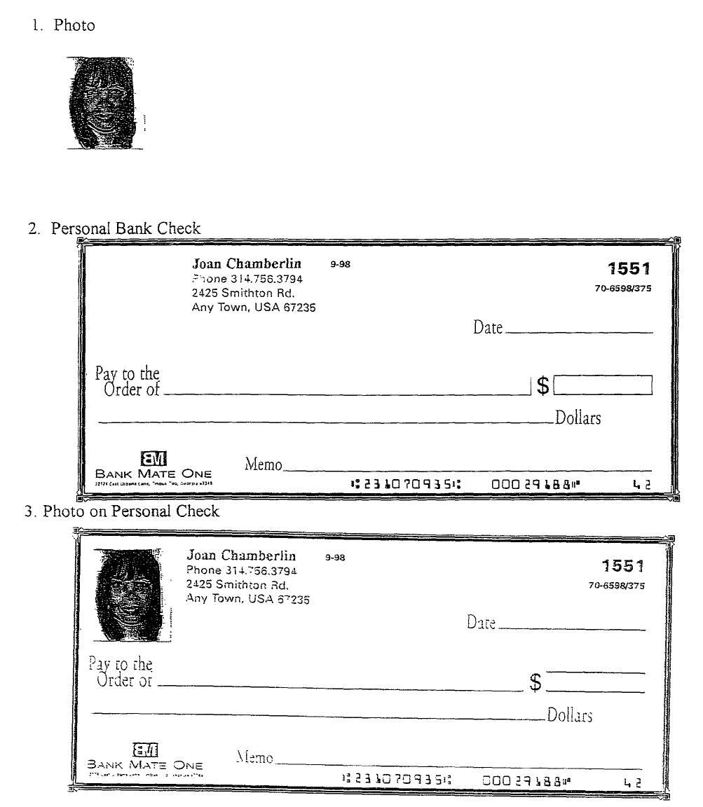

### DETAILED DESCRIPTION OF THE INVENTION

The Photocheck contains a 1 in×¾ in color photo located in the upper left hand corner of the check next to the consumers name and address information.

The actual invention claims for Photocheck:

1. Photograph on personal bank check

2. Prior to this patent submission, there were no photographs on personal bank checks.
